(19) United States
(12) Patent Application Publication
(10) Pub. No.: US 2012/0041834 A1
(43) Pub. Date: Feb. 16, 2012

(54) System and Method for Utilizing Media Content to Initiate Conversations between Businesses and Consumers

(76) Inventor: James Duncan McRae, II, Windermere, FL (US)

(21) Appl. No.: 13/209,235

(22) Filed: Aug. 12, 2011

Related U.S. Application Data
(60) Provisional application No. 61/373,407, filed on Aug. 13, 2010.

(51) Int. Cl. G06Q 30/00

(52) U.S. Cl. 705/26.3

(57) ABSTRACT

A Content Management System can utilize professionally edited content to initiate conversations between businesses and consumers. The Content Management System can function as a third party between businesses (e.g., merchants selling products or services) and publishers creating content that may be of interest to the target markets of the businesses. The Content Management System can allow publishers of editorial quality content to submit content electronically (e.g., through a web-enabled intake engine or a file server). Content submitted can be matched to potentially interested businesses based on contextual information gathered from or inferred from the content. The Content Management System can automate the matching and monetization of the content. As an incentive for the business purchasing the content, the Content Management System can provide conversation tools to link consumers to marketing and sales functions of a purchaser's business.

### RELATED APPLICATIONS

This application claims the benefit of U.S. Provisional Application No. 61/373,407 filed Aug. 13, 2010, the content of which is incorporated by this reference in its entirety for all purposes as if fully set forth herein.

### TECHNICAL FIELD OF THE INVENTION

The present invention relates generally to the field of publishing of electronic content. More particularly, the present invention relates to matching and monetization of published electronic content.

### BACKGROUND

Journalism, in the digital world, involves much more than publishing quality content. The content publishers are also involved in tasks such as selling subscriptions to readers and selling and creating advertising campaigns. If the publisher has both an online presence and a print product, the advertising campaigns and subscriptions sales take on added complexity.

Electronic content is often monetized through online subscription sales, keyword advertising, in-text ads, and other forms of link advertising. To aid in content monetization, some publishers use keyword stuffing, tagging, and linking to improve the hit rate through search engine queries.

Although online content has historically been located mainly through the use of search engine queries, social media sites have provided the opportunity for socially networked users to share content of interest with peers. Many social media sites provide the opportunity for users to post content or a uniform resource indicator (URI) or uniform resource locator (URL) to the content and then, in association with the content, hold a discussion between the peers of the user.

### SUMMARY

A Content Management System can utilize professionally edited content to initiate conversations between businesses and consumers. As used within, content can include any text, video, graphic, multimedia, or metadata information, alone or combined, which has the purpose of providing editorial information to a consumer. Conversations, as used herein, can include both real-time and messaging-based exchanges of information (text, audio, multimedia, etc.) through a network connection, including email. The Content Management System can function as a third party between businesses (e.g., merchants selling products or services) and publishers creating content that may be of interest to the target markets of the businesses. The Content Management System can allow publishers of editorial quality content to create a publisher account and submit content items electronically (e.g., through a web-enabled intake engine or a file server). Content submitted can be matched to potentially interested businesses based on contextual information gathered from or inferred from the content. For example, the Content Management System can allow a business to create a business account, wherein the business account may include a list of keywords associated with the business for the purpose of correlation with a list of keywords in content items. The Content Management System can support multimedia content so that any combination of video, audio, animation, or text may be submitted. The Content Management System can automate the matching and monetization of the content. As an incentive for the business purchasing the content, the Content Management System can provide conversation tools to link consumers to marketing and sales functions of a purchaser's business. There can be more than one purchaser for each piece of content.

In some implementations, the Content Management System can further function as a third-party editorial wall between advertising revenue and the publisher. The Content Management System can enable third-party auditors to determine that accurate and true accounting is maintained for content purchasers and also for the publishers. The Content Management System, in this configuration, may not inform publishers how much money is made from any given purchaser.

The Content Management System can enable publishers to submit content into the Content Management System over a network connection, such as the Internet. The Content Management System can automate the matching of content to potentially interested businesses using a contextual analysis algorithm. The algorithm can also identify the positive, neutral, or negative stance of the content towards each matching business. The algorithm can automate the editorial process needed to aggregate and publish content recommendations for every business with one or more content matches.

### BRIEF DESCRIPTION OF DRAWINGS

Further advantages of the present invention may become apparent to those skilled in the art with the benefit of the following detailed description of the best presently known mode of practicing the invention, and upon reference to the accompanying drawings in which:

FIG. 1 illustrates major subsystems of an example of a Content Management System; and

FIG. 2 is a schematic diagram of one example of a computer system.

Like reference symbols in various drawings indicate like elements.

### DETAILED DESCRIPTION OF ILLUSTRATIVE IMPLEMENTATIONS

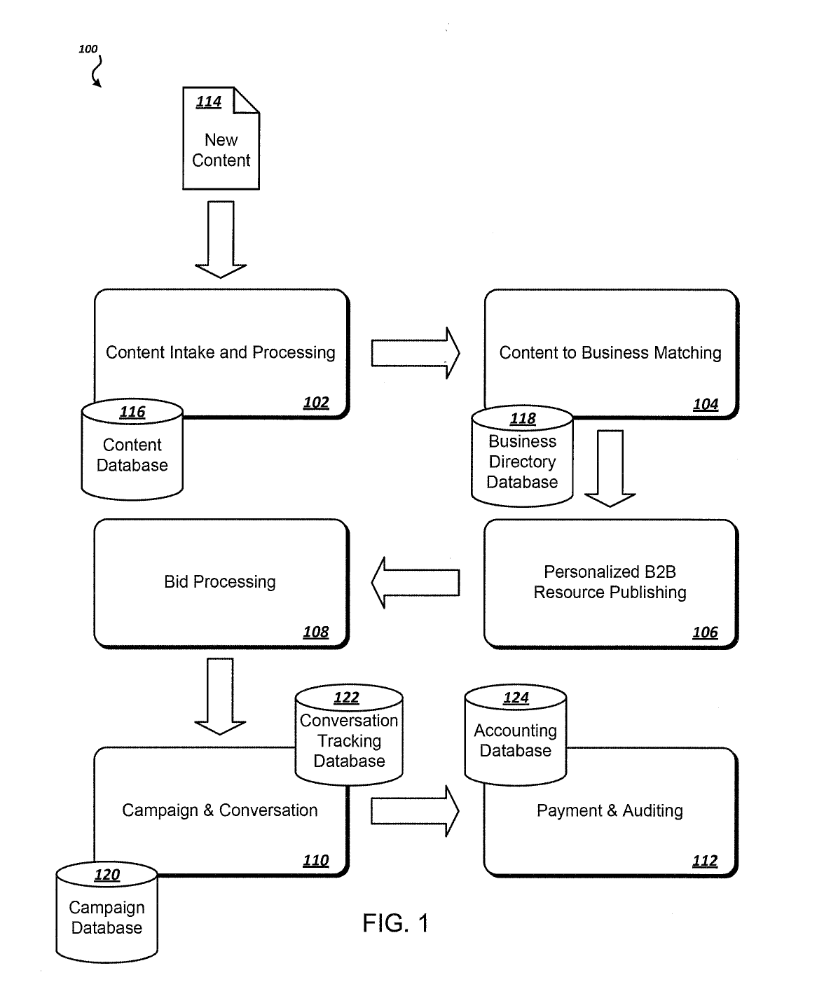

FIG. 1 illustrates major subsystems of an example of a Content Management System 100. Each subsystem performs a distinct role and may be implemented, in some implementations, using different software technologies. Communication between subsystems, for example, can be accomplished using databases maintained by each subsystem and/or web requests.

A publisher can participate in the Content Management System 100 by providing content items, such as text articles, videos, and multimedia presentations. In some implementations, the publisher can provide contextual information associated with individual content items, such as an industry vertical.

A Content Intake and Processing subsystem 102 includes a content management portal for receiving content such as a new content item 114 from a publisher. The Content Intake and Processing subsystem 102 can include an analysis engine to analyze the new content item 114 and a content database 116 for storing the new content item 114 and any other information, such as metadata, associated with the new content item 114 through analysis. New content can be submitted through an automated content management portal, for example, available through a network portal server (e.g., Intranet, WAN, LAN, WLAN, intranet, extranet, or a combination thereof). The content source and any associated contextual information can be captured by the submission process. The Content Intake and Processing subsystem 102 can analyze the new content item 114. The content analysis algorithm can produce a list of businesses and keywords associated with the new content item 114. The Content Intake and Processing subsystem 102, in some implementations, applies optical character recognition to graphics or voice recognition software to an audio portion of the new content item 114 to locate contextual keywords. The keywords, in some implementations, include company names provided by one or more businesses participating in the Content Management System 100. In some implementations, the algorithm also categorizes the new content item 114 into one of several industry verticals, or categories, such as entertainment, health, automotive, or housing. The Content Intake and Processing subsystem 102 can then populate a content database 116 with the contextual analysis, generated meta-information, and the new content item 114 itself. Other subsystems can access the content database 116 to retrieve a portion of this information.

A business can participate in the Content Management System 100 by providing a campaign budget and, optionally, a bidder profile. The bidder profile can include one or more industry verticals of interest, one or more keywords and, optionally, an editorial stance towards one or more of the keywords. The editorial stance can supply a positive, neutral, or negative standing towards a keyword or keyword phrase. For example, the business can submit a positive stance towards a company name and brand name associated with the business. In some implementations, the business can request a desired type or length of content. For example, the business can specify videos no longer than three minutes or articles no greater than eight hundred words.

The Content to Business Matching subsystem 104 matches content to potentially interested businesses through an automated process. A matching algorithm, for example, generates a list of recommended businesses for each new piece of content in the Content Management System 100. The matching algorithm uses many different kinds of variables to create a match including contextual information generated by the Content Intake and Processing subsystem 102. In one example, the algorithm matches content to potential businesses using keywords and phrases within a textual portion of the content. In another example, the algorithm utilizes names of companies located within a portion of the content and matches to a positive, neutral, or negative stance related to a particular company name. In examples of a Content Management System, the Content to Business Matching subsystem may match a first content item to a first business based in part upon a correlation between a first list of keywords associated with the first content item and a second list of keywords associated with the first business.

The list of companies, for example, can be obtained from a business directory database 118 maintained by the Content to Business Matching subsystem 104. The other subsystems of the Content Management System 100, in some implementations, also have access to the business directory database 118. The business directory database 118 can also contain contextual information about the services or products provided by each business. This information, in some implementations, can be reviewed and normalized by editorial staff so that automated matching is possible using contextual information such as keywords or the positive/neutral/negative stance towards a brand, company name, or product/service offering.

The Content to Business Matching subsystem 104, in some implementations, also includes an algorithm that estimates the monetary value of content upon determining a list of potentially interested businesses. The estimated value of content, for example, can be used by a Bid Processing subsystem 108.

A Personalized Business-to-Business (B2B) Resource Publishing subsystem 106 is responsible for publishing a B2B online resource, such as a web page or web site, displaying content recommendations for a business. Each business participating in the Content Management System 100 can bid on or, in some implementations, immediately purchase the rights to host the content displayed on the respective B2B online resource. In some implementations, the B2B online resource can be displayed using a private web site protected by password access. A front page can be individualized for a particular business using a content recommendation algorithm that takes into account the past content purchases made by the business. The content recommendation algorithm, in some implementations, can also allow an authorized user, such as a Content Management System staff member, to manually bias the recommendations based on keywords or phrases that have a high value to a particular business.

A Bid Processing subsystem 108 manages the bids on content from interested businesses. Bids are collected from the B2B online resources generated by the Personalized B2B Resource Publishing subsystem 106. The Bid Processing subsystem 108 automates the bidding process, including any communication between the Bid Processing subsystem 108 and all bidders. A bidding algorithm can determine the winning bid based on various factors. Some factors include, for example, the amount of the bid, expiration time on the “freshness” of the content, how long a business wishes to purchase rights to hosting the content, and whether exclusivity is requested by the bidder. The algorithm can also consider the estimated value of the content. In some implementations, if the bidding algorithm includes a bid resolution process capable of resolving any tie situations, where two or more bidders rank equally for a single content item.

Any content purchased through the Bid Processing subsystem 108 can be treated as a campaign involving the business, and the lifespan of the campaign can be tracked by a Campaign and Conversation subsystem 110 using a campaign database 120. The campaign database 120, in some implementations, can also be accessed by a Payment and Auditing subsystem 112.

The Campaign and Conversation subsystem 110 manages the campaign activity and reporting for content that has one or more winning bidders. The Campaign and Conversation subsystem 110 can include the management of client-side or server-side tools that allow readers of the content to initiate contact with the business that has purchased and is therefore hosting the content. The content for a campaign can be delivered in at least two possible ways. A first method for content delivery involves displaying the content directly through an online resource, such as a web page or web site, controlled by the business that won the bid for the content. A second method for content delivery involves integrating, through an online resource in control of the publisher of the content, the display of the content along with conversation tools directed towards the business that won the bid for the content. The conversation tools, for example, can include widgets or interactive functions used to drive the interest of readers of the content to online resources of the business, such as a corporate website or a social network page managed by the business.

The Campaign and Conversation subsystem 110, in some implementations, can maintain records, for example in a conversation-tracking database 122, tracking the number of conversations generated by each piece of content. A report on the number and type of conversations generated, for example, can be provided to the business purchasing hosting rights to the content.

The Payment and Auditing subsystem 112 manages the receipt of payments made by businesses hosting content and the periodic issuance of payouts made to content publishers participating in the Content Management System 100. The Payment and Auditing subsystem 112, in some implementations, maintains an accounting database 124 allowing a third party financial auditing agency to independently verify that payments made to publishers are both accurate and true without having to disclose any details about the monetization of the content or the identity of the hosting business to the publisher. The accounting database 124 can also allow the Content Management System 100 to track the start and end status of a campaign.

The Content Management System 100, for example, can be built using current software technologies. One example is the use of web servers running the Linux operating system with system code developed in the PhP programming language. User interaction can be built using HTML, JavaScript, and CSS. The data storage for the accounting, audit, business profiles, and content (e.g., the content database 116, the business directory database 118, the conversation tracking database, the campaign database 120, and/or the accounting database 124) can be implemented using MySQL databases. Communication between the Content Management System 100, the businesses, and the publishers can be accomplished over the Internet.

There are several ways the Content Management System 100 can provide valuable content for use in advertising or marketing a business. In one example, the Content Management System 100 can provide a branded marketing platform capable of integrating high value content directly with consumer interaction. The Content Management System 100, for instance, can be used to allow the marketing departments of businesses to preserve or enhance their brands nationwide (or globally) by purchasing and hosting valuable content items related to products and services of the business. For example, content related to products and services of the business can be automatically located by the Content to Business Matching subsystem 104, for example based upon keywords related to products and services as provided by the business. The Personalized B2B Resource Publishing subsystem 106 can then present the content items relating to products and services of the business to the business for bidding or purchase. Upon winning the bid, through the Bid Processing subsystem 108, the Content Management System 100 can generate a campaign on behalf of the business, through the Campaign and Conversion subsystem 110. For example, the Campaign and Conversion subsystem 110 can make the content accessible via search engines and news aggregation sites. Additionally, in some implementations, the Campaign and Conversion subsystem 110 can embed conversation tools with the content so that viewers of the content are provided with one-click access to communicate with the marketing channel of the sponsoring business.

In another example, the Content Management System 100 can provide a platform for a small town local community to publish local community interest stories and monetize the content through sponsorship from local businesses. The Content Management System 100 can attract local businesses that are referenced in the context of the content by automatically locating keywords associated with local businesses using the Content Intake and Processing subsystem 102, then relating the keywords with particular local businesses through the Content to Business Matching subsystem 104. The content, as determined through the Content to Business Matching subsystem 104, is likely to have a high engagement value between the local businesses and community.

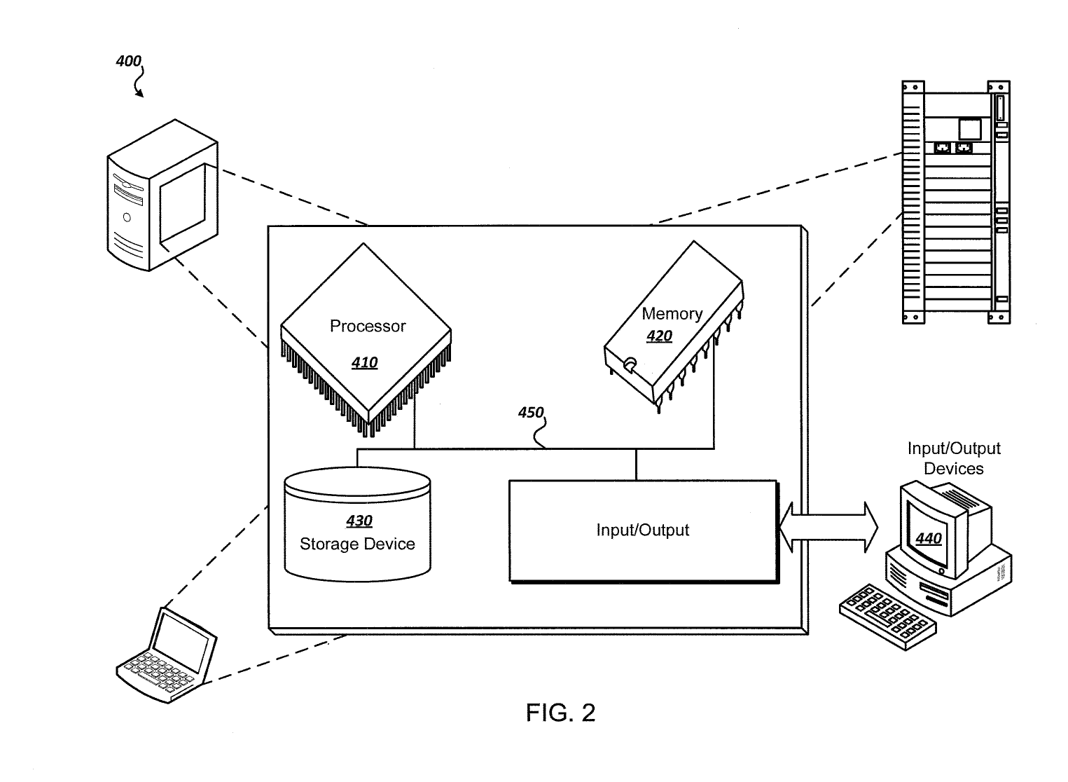

FIG. 2 is a schematic diagram of one example of a computer system 200. The system 200 is optionally used for the operations described in association with any of the computer-implemented methods described previously, according to one implementation. The system 200 includes a processor 210, a memory 220, a storage device 230, and an input/output device 240. Each of the components 210, 220, 230, and 240 are interconnected using a system bus 250. The processor 210 is capable of processing instructions for execution within the system 200. In one implementation, the processor 210 is a single-threaded processor. In another implementation, the processor 210 is a multi-threaded processor. The processor 210 is capable of processing instructions stored in the memory 220 or on the storage device 230 to display graphical information for a user interface on the input/output device 240.

The memory 220 stores information within the system 200. In one implementation, the memory 220 is a computer-readable medium. In one implementation, the memory 220 is a volatile memory unit. In another implementation, the memory 220 is a non-volatile memory unit.

The storage device 230 is capable of providing mass storage for the system 200. In one implementation, the storage device 230 is a computer-readable medium. In various different implementations, the storage device 230 is optionally a floppy disk device, a hard disk device, an optical disk device, or a tape device.

The input/output device 240 provides input/output operations for the system 200. In one implementation, the input/output device 240 includes a keyboard and/or pointing device. In another implementation, the input/output device 240 includes a display unit for displaying graphical user interfaces.

In some examples, the features described are implemented in digital electronic circuitry, or in computer hardware, firmware, software, or in combinations of them. The apparatus is optionally implemented in a computer program product tangibly embodied in an information carrier, e.g., in a machine-readable storage device or in a propagated signal, for execution by a programmable processor; and method steps are performed by a programmable processor executing a program of instructions to perform functions of the described implementations by operating on input data and generating output. The described features are optionally implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that are optionally used, directly or indirectly, in a computer to perform a certain activity or bring about a certain result. A computer program is optionally written in any form of programming language, including compiled or interpreted languages, and it is deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory are optionally supplemented by, or incorporated in, ASICs (application-specific integrated circuits).

To provide for interaction with a user, the features in some instances are implemented on a computer having a display device such as a CRT (cathode ray tube) or LCD (liquid crystal display) monitor for displaying information to the user and a keyboard and a pointing device such as a mouse or a trackball by which the user provides input to the computer.

The features are optionally implemented in a computer system that includes a back-end component, such as a data server, or that includes a middleware component, such as an application server or an Internet server, or that includes a front-end component, such as a client computer having a graphical user interface or an Internet browser, or any combination of them. The components of the system are connected by any form or medium of digital data communication such as a communication network. Examples of communication networks include, e.g., a LAN, a WAN, and the computers and networks forming the Internet.

The computer system optionally includes clients and servers. A client and server are generally remote from each other and typically interact through a network, such as the described one. The relationship of client and server arises by virtue of computer programs running on the respective computers and having a client-server relationship to each other.

The foregoing detailed description of embodiments of the invention is intended to be illustrative and not intended to limit the scope of the invention. Changes and modifications are possible with respect to the foregoing description, and it is understood that the invention may be practiced otherwise than that specifically described herein and still be within the scope of the claim.

What is claimed is:

1. A content management system comprising:
a content intake and processing subsystem including a content management portal and a content database including two or more content items, wherein
a publisher creates a publisher account with the content management system,
the publisher submits a first content item to the content management portal using the publisher account, and
the content intake and processing subsystem analyzes the first content item, wherein analyzing includes producing a first list of keywords associated with the content;
a content to business matching subsystem including a business directory database, wherein
a first business creates a business account with the content management system, the business account including a second list of keywords associated with the first business, and
the content to business matching subsystem matches the first content item to the first business based in part upon a correlation between the first list of keywords and the second list of keywords;
a personalized business to business resource publishing subsystem configured to generate an online resource for the first business, and
present the first content item to the first business for bidding through the online resource, wherein
the first business submits a bid for the first content item through the online resource; and
a bid processing subsystem configured to
apply a bidding algorithm to the first business and a second business relating to the first content item,
determine a winning bid associated with the first business, and
fulfill a purchase for the first content item by the first business.

2. The content management system of claim 1, further comprising a payment and auditing subsystem configured to provide payment to the publisher from the first business, the payment relating to the purchase of the first content item, wherein
a third party auditor verifies the payment, and wherein
the content management system firewalls the publisher from details related to the payment.

3. The content management system of claim 1, wherein
one or more of the second list of keywords are associated with a respective stance, the stance being one of positive, negative, or neutral, and
wherein the content to business matching subsystem further matches the first content item to the first business based upon the respective stance of one or more of the second list of keywords which correlated to the first list of keywords.

4. The content management system of claim 1, further comprising a campaign and conversation subsystem configured to manage a campaign associated with the purchase, wherein the campaign includes conversation tools that allow one or more users to initiate contact with the first business through the first content item.

5. A method for managing content in a content management system comprising:
receiving, from a publisher, at a content management portal, a first content item;
analyzing the first content item, wherein analyzing includes producing a first list of keywords associated with the content;
accessing a business account, the business account previously created in the content management system by a first business, the business account including a second list of keywords associated with the first business;
matching the first content item to the first business based in part upon a correlation between the first list of keywords and the second list of keywords;
presenting the first content item to the first business for bidding through an online resource;
receiving a bid for the first content item from the first business through the online resource;
fulfilling a purchase for the first content item by the first business; and
creating a campaign associated with the purchase, wherein the campaign includes conversation tools that allow one or more users to initiate contact with the first business through the first content item.

6. A content management system comprising:
a content intake and processing subsystem including a content management portal and a content database including two or more content items, wherein
the content management system allows a publisher to create a publisher account,
the intake and processing subsystem allows a publisher to submit a first content item to the content management portal using the publisher account, and
the content intake and processing subsystem analyzes the first content item, wherein analyzing includes producing a first list of keywords associated with the content;
a content to business matching subsystem including a business directory database, wherein
the content management system allows a first business to create a business account, the business account including a second list of keywords associated with the first business, and
the content to business matching subsystem matches the first content item to the first business based in part upon a correlation between the first list of keywords and the second list of keywords;
a personalized business to business resource publishing subsystem configured to generate an online resource for the first business, and
present the first content item to the first business for bidding through the online resource, wherein
the first business submits a bid for the first content item through the online resource; and
a bid processing subsystem configured to
apply a bidding algorithm to the first business and a second business relating to the first content item,
determine a winning bid associated with the first business, and
fulfill a purchase for the first content item by the first business.

7. The content management system of claim 6, further comprising a payment and auditing subsystem configured to provide payment to the publisher from the first business, the payment relating to the purchase of the first content item, wherein
the payment and auditing subsystem allows a third party auditor to verify the payment, and wherein
the content management system firewalls the publisher from details related to the payment.

8. The content management system of claim 6, wherein
one or more of the second list of keywords are associated with a respective stance, the stance being one of positive, negative, or neutral, and
wherein the content to business matching subsystem further matches the first content item to the first business based upon the respective stance of one or more of the second list of keywords which correlated to the first list of keywords.

9. The content management system of claim 6, further comprising a campaign and conversation subsystem configured to manage a campaign associated with the purchase, wherein the campaign includes conversation tools that allow one or more users to initiate contact with the first business through the first content item.
